(19) United States
(12) Patent Application Publication
(10) Pub. No.: US 2011/0061958 A1
(43) Pub. Date: Mar. 17, 2011

(54) POWER SYSTEM FOR ELECTRIC VEHICLES WHICH EMPLOY MODULAR EXCHANGEABLE BATTERY PACKS

(76) Inventor: Ronald L. Morgan, Mountain View, CA (US)

(21) Appl. No.: 12/561,485

(22) Filed: Sep. 17, 2009

(51) Int. Cl. B60R 16/04; H01M 6/42

(52) U.S. Cl. 180/68.5; 429/158

(57) ABSTRACT

A power system is enclosed, which may comprise one or more modular and exchangeable battery packs; at least one of the battery packs comprising one or more individual electrochemical cells, a housing, and a first blind electrical connector; one or more connection buses; and at least one of the connection buses comprising a plurality of second blind electrical connectors disposed to self align with the first blind electrical connectors of the battery packs.

### BACKGROUND OF THE INVENTION

The present invention generally relates to power systems, and more particularly to a power system employing modular exchangeable battery packs.

In recent years, increased concerns over the environmental impact of gasoline cars, along with reduced consumer ability to pay for fuel for gasoline cars, has brought about a lot of interest in electric cars. Currently, electric cars enjoy relative popularity in countries around the world, though they are notably absent from the roads of the United States. This is due in part to the inability of the current electric car technology to complete a trip in the same length of time as would a traditional gasoline car. This is due to the limited range of current electric cars and the often extended recharge time.

As can be seen, there is a need for a more effective and efficient power system for electric cars.

### SUMMARY OF THE INVENTION

In one aspect of the present invention, a power system, comprises one or more modular and exchangeable battery packs; at least one of the battery packs comprising one or more individual electrochemical cells, a housing, and a first blind electrical connector; one or more connection buses; and at least one of the connection buses comprising a plurality of second blind electrical connectors disposed to self align with the first blind electrical connectors of the battery packs.

In another aspect of the present invention, an electric vehicle, comprises one or more electric motors for propulsion of the electric vehicle; one or more hollow cavities for enclosing one or more modular and exchangeable battery packs; at least of the battery packs comprising one or more individual electrochemical cells, a housing, and a first blind electrical connector; wherein the one or more cavities are configured in the electric vehicle to distribute weight of the one or more battery packs; one or more connection buses; and at least one of the connection buses comprising a plurality of second blind electrical connectors disposed to self align with the first blind electrical connectors of the battery packs.

These and other features, aspects and advantages of the present invention will become better understood with reference to the following drawings, description and claims.

### BRIEF DESCRIPTION OF THE DRAWINGS

FIG. 1 shows a perspective view of an embodiment of the modular battery pack of the present invention;

FIG. 2 shows a front view of an embodiment of the present invention;

FIG. 3 shows a back view of an embodiment of the present invention;

FIG. 4 shows a top view of an embodiment of the present invention;

FIG. 5 shows a side view of an embodiment of the present invention;

FIG. 6 shows a perspective view of an embodiment of the present invention.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Various inventive features are described below that can each be used independently of one another or in combination with other features.

Broadly, embodiments of the present invention generally provide a power system employing modular battery packs that may be attached to a back plane or a bus. Multiple battery packs may be connected together as a singular unit where individual battery packs may be exchanged at will or a single battery pack module may be used depending on the application. Exemplary applications of using the battery packs of the present invention include electric vehicles, such as automobiles where battery packs may be in a single location or distributed throughout the automobile frame where needed and to distribute the weight of the battery packs. The battery packs of the present invention may also be used in buildings, such as residential homes, commercial buildings, hospitals, and the like as a backup power source that can be tapped into when grid power drops.

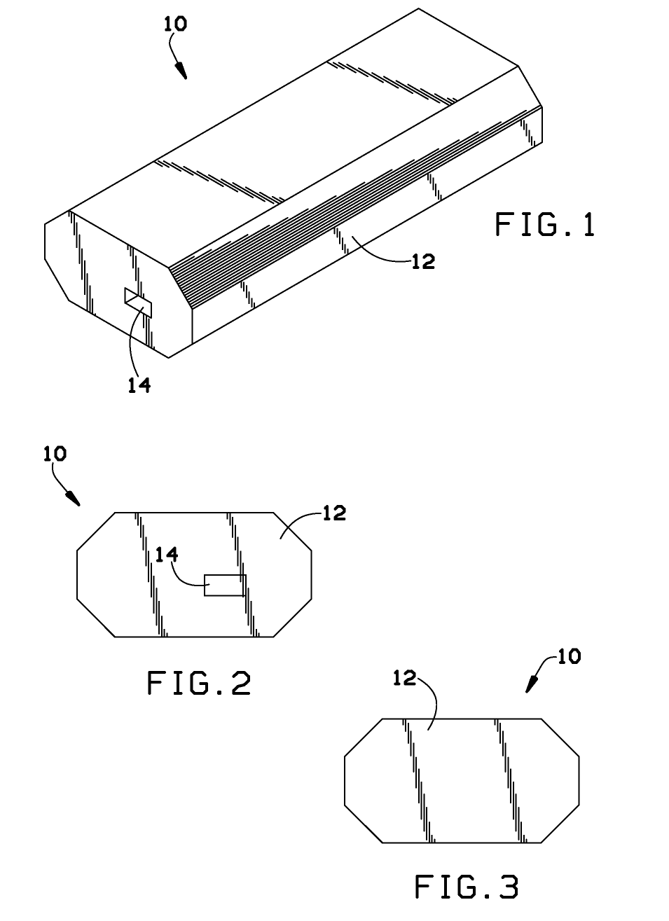

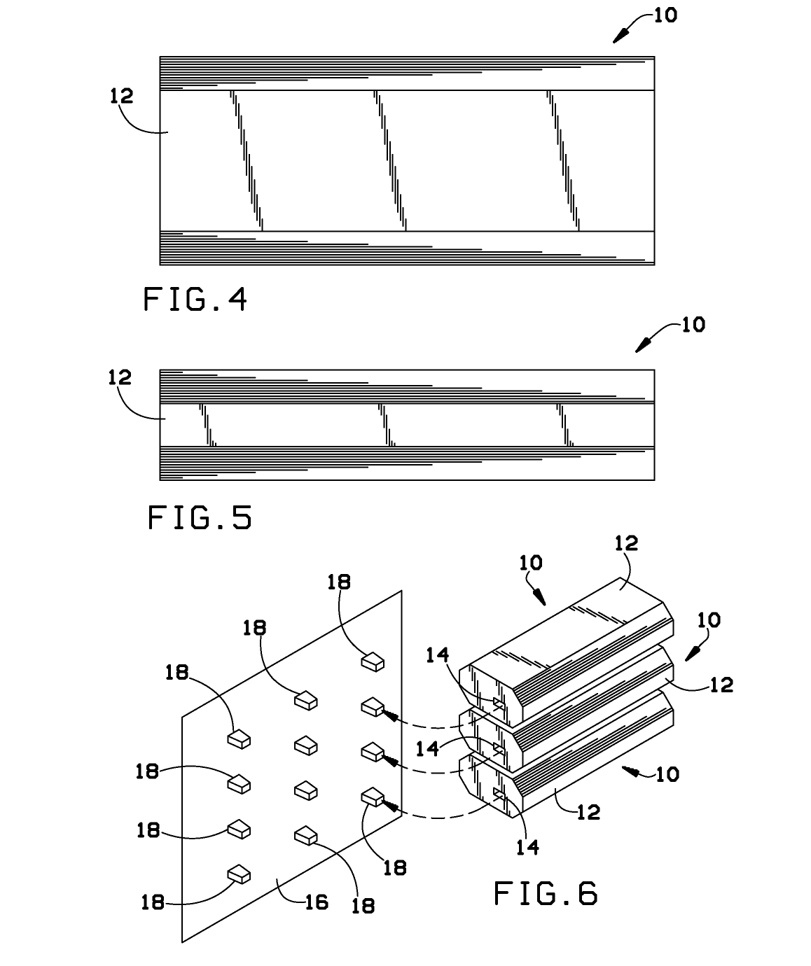

Referring to FIGS. 1 through 6, an exemplary embodiment of a power system 10 may be illustrated in general according to the following description. Battery packs 12 may be comprised of individual electrochemical cells (not shown), the module housing, and a blind self aligning electrical connector 14. A back plane may be provided in the form of a connection bus 16 having a plurality of blind electrical connectors 18 that are configured to self align with the blind electrical connectors 14 of the battery packs 12.

The individual electrochemical cells may be connected to each other in a manner to produce the desired current and voltage, for example 156 volts. It will be understood that the individual electrochemical cells may be arranged in series or in parallel to produce the desired voltage. For example, when the individual electrochemical cells are arranged in series, the positive and negative ends of the series are connected to the self aligning connector 14. Individual electrochemical cells may use a variety of battery chemistry, for example nickel metal hydride, lithium ion, and/or lithium iron phosphate.

The individual electrochemical cells may be enclosed in a housing of a standard shape and size, where the self aligning electrical connector 14 is the output from the battery pack 12 to the connection bus 16, which in turn conducts the electricity to the controller and motor(s). The self aligning electrical connectors 14, 18 may be configured in any suitable manner to connect the battery packs 12 to the connection bus 16, for example in a male-female configuration. The electrical connector 14 of the battery pack 12 may be placed off centered on a surface of the battery pack 12, in order to allow the battery pack 12 to slide into its location on the connection bus 16 in only one way to assure the correct polarity of the connection. This connection allows the electricity to be conducted to the vehicle controller and motor(s) in such as way that when one or more battery packs 12 become depleted of its charge, it can be easily exchanged, for example by hand, for a fully charge battery pack 12, thus allowing an electric vehicle to have an unlimited range. By way of example, the battery pack 12 may have a length of 27 inches, a width of 11 1/16 inches, and a height of 6 inches.

The modular nature of the battery packs 12 can allow automotive designers to vary the voltage, kilowatts, and range available for a vehicle by varying the number and arrangement of the modules. Rather than using a single battery pack which is common among current electric cars, the battery packs 12 of the present invention can be distributed throughout the vehicle to improve weight distribution, handling, and design possibilities. Each module 12 can be of a weight that can be exchanged for a freshly charged module by an average adult or a small robotic exchanger without the need for heavy lifting equipment. The modules can be usable among several types of electric vehicles, and these modules can be arranged and provided at a conventional service station with the current infrastructure. No additional infrastructure would be needed to be developed, unlike the additional infrastructure required to support development of hydrogen fuel cells.

It should be understood, of course, that the foregoing relates to exemplary embodiments of the invention and that modifications may be made without departing from the spirit and scope of the invention as set forth in the following claims.

I claim:

1. A power system, comprising:
one or more modular and exchangeable battery packs;
at least one of the battery packs comprising one or more individual electrochemical cells, a housing, and a first blind electrical connector;
one or more connection buses; and
at least one of the connection buses comprising a plurality of second blind electrical connectors disposed to self align with the first blind electrical connectors of the battery packs.

2. The power system of claim 1, wherein the individual electrochemical cells are arranged in series to produce voltage.

3. The power system of claim 1, wherein the individual electrochemical cells are arranged in parallel to produce voltage.

4. The power system of claim 1, wherein the first blind electrical connector of the battery back is off centered to allow the battery pack to be self aligned with the second blind electrical connector of the bus in only one direction to assure correct polarity.

5. The power system of claim 1, wherein the first and second electrical connectors have a male-female self aligning configuration.

6. The power system of claim 1, wherein each of the battery packs comprise a length of 27 inches, a width of 11 1/16 inches, and a height of 6 inches.

7. The power system of claim 1, wherein each battery pack produces 156 volts.

8. An electric vehicle, comprising:
one or more electric motors for propulsion of the electric vehicle;
one or more hollow cavities for enclosing one or more modular and exchangeable battery packs;
at least of the battery packs comprising one or more individual electrochemical cells, a housing, and a first blind electrical connector;
wherein the one or more cavities are configured in the electric vehicle to distribute weight of the one or more battery packs;
one or more connection buses; and
at least one of the connection buses comprising a plurality of second blind electrical connectors disposed to self align with the first blind electrical connectors of the battery packs.

9. The electric vehicle of claim 8, wherein battery chemistry of the individual electrochemical cells is selected from the group consisting of nickel metal hydride, lithium ion, and lithium iron phosphate.

10. The electric vehicle of claim 8, wherein the housing of the battery packs comprise a standard shape and size.

11. The electric vehicle of claim 8, wherein the battery packs are configured to be exchangeable by hand.
